(19) United States
(12) Patent Application Publication
(10) Pub. No.: US 2026/0360603 A1
(43) Pub. Date: Nov. 12, 2026

(54) REACTOR, CONVERTER, AND POWER CONVERSION APPARATUS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Masato NADA, Mie (JP); Shinichiro YAMAMOTO, Mie (JP)

(21) Appl. No.: 19/134,749

(22) PCT Filed: Dec. 4, 2023
(86) PCT No.: PCT/JP2023/043337

§ 371 Date: Jun. 2, 2025

(30) Foreign Application Priority Data
Dec. 9, 2022 (JP) 2022-197373

(51) Int. Cl. H01F 27/24; H01F 27/28; H02P 27/06

(52) U.S. Cl. CPC H01F 27/24; H01F 27/28; H02P 27/06

(57) ABSTRACT

This reactor comprises: a coil composed of a spirally-wound winding; and a core formed so as to pass through the inside and the outside of the coil. The number of coils is one. The core has: a middle core disposed inside the coil; a side core disposed in parallel with the middle core without having the coil disposed thereon; a first end core connected to a first end of the middle core and to a first end of the side core; and a second end core connected to a second end of the middle core and to a second end of the side core. The middle core is wider than the side core.

### TECHNICAL FIELD

The present disclosure relates to a reactor, a converter, and a power conversion apparatus.

This application claims priority based on Japanese Patent Application No. 2022-197373, filed Dec. 9, 2022, the entire contents of which are incorporated herein by reference.

### BACKGROUND

A reactor of Patent Document 1 includes a coil and a magnetic core. The coil has a first winding portion and a second winding portion, which are constituted by windings wound in a spiral shape. The magnetic core includes a first middle core, a second middle core, a first end core, and a second end core. The first middle core is located inside the first winding portion. The second middle core is located inside the second winding portion. The first middle core and the second middle core have the same width. The first middle core has a thickness larger than its width. The first end core connects a first end of the first middle core and a first end of the second middle core. The second end core connects a second end of the first middle core and a second end of the second middle core.

### PRIOR ART DOCUMENT

### Patent Document

Patent Document 1: JP 2006-351722 A

### SUMMARY OF THE INVENTION

A reactor of the present disclosure includes: a coil including a spirally wound winding; and a core formed to pass through an inside and outside of the coil. There is one coil. The core includes: a middle core disposed inside the coil; a side core arranged in parallel with the middle core, without the coil being disposed on the side core; a first end core connected to a first end of the middle core and a first end of the side core; and a second end core connected to a second end of the middle core and a second end of the side core. The middle core has a width larger than a width of the side core.

### BRIEF DESCRIPTION OF THE DRAWINGS

FIG. 1 is a schematic perspective view of an entire reactor of Embodiment 1.

FIG. 2 is a schematic perspective view of the reactor of Embodiment 1 in an exploded state.

FIG. 3 is a III-III cross-sectional view of FIG. 1.

FIG. 4 is a IV-IV cross-sectional view of FIG. 1.

FIG. 5 is an illustrative view of a first outer peripheral shape of a coil, a second outer peripheral shape of a first end core, a third outer peripheral shape of a middle core, and a fourth outer peripheral shape of a side core in the reactor of Embodiment 1.

FIG. 6 schematically shows a configuration of a power supply system of a hybrid automobile.

FIG. 7 is a circuit diagram showing an example of a power conversion apparatus that includes a converter.

### DETAILED DESCRIPTION TO EXECUTE THE INVENTION

### Problem to be Solved by the Present Disclosure

Further improvements in heat dissipation properties are desired.

An object of the present disclosure is to provide a reactor that has excellent heat dissipation properties.

### Advantageous Effects of Invention

The reactor of the present disclosure has excellent heat dissipation properties.

### Description of Embodiments of the Present Disclosure

First, modes for carrying out the present disclosure are listed and described.

(1) A reactor according to one aspect of the present disclosure includes: a coil including a spirally wound winding; and a core formed to pass through an inside and outside of the coil. There is one coil, the core includes: a middle core disposed inside the coil; a side core arranged in parallel with the middle core, without the coil being disposed on the side core; a first end core connected to a first end of the middle core and a first end of the side core; and a second end core connected to a second end of the middle core and a second end of the side core. The middle core has a width larger than a width of the side core.

The reactor according to (1) above has excellent heat dissipation properties. In the reactor according to (1) above, the coil is disposed on the middle core having a larger width than the side core, and thus has a larger width than that of a reactor W in which the coil is disposed on the middle core having the same width as the side core. When the reactor according to (1) above is installed on a planar installation target, a surface of the coil that has a large width comes into contact with the installation target. Thus, with the reactor according to (1) above, the contact area between the coil and the installation target can be made larger than with the above reactor W. Therefore, the reactor according to (1) above can transfer the heat from the coil to the installation target more easily than the reactor W.

The reactor according to (1) above has excellent inductance. In the reactor according to (1) above, the coil is disposed on the middle core having a larger width than the side core, and the cross-sectional area of the coil can thereby be made larger than that of the reactor W. Thus, even though the reactor according to (1) above has only one coil, the inductance thereof can be easily made larger than that of the reactor W.

The reactor according to (1) above has excellent producibility. This is because, with the reactor according to (1) above having one coil, the coil can be more easily shaped than in the case of a reactor having more than one coil. Another reason is that the reactor according to (1) above having one coil has a smaller number of components than a reactor having more than one coil.

(2) In the reactor according to (1) above, the coil may have a first outer peripheral shape that is a rectangular shape as viewed from a first direction along an axis of the coil, the coil may have an outer peripheral surface including a first coil surface and a second coil surface facing each other and extending along respective long sides of the first outer circumferential shape, the first end core and the second end core may each have an outer peripheral surface including a first core surface and a second core surface facing each other, and the first core surface of the first end core and the first core surface of the second end core may be substantially flush with the first coil surface.

The reactor according to (2) above has excellent heat dissipation properties. The first core surface of the first end core and the first core surface of the second end core are substantially flush with the first coil surface. When the reactor according to (2) above is installed on a planar installation target, the first coil surface, the first core surface of the first end core, and the first core surface of the second end core come into contact with the installation target. Thus, the reactor according to (2) above can increase the contact area between the reactor and the installation target compared to a reactor X in which only the first coil surface of the coil comes into contact with the installation target without the first core surface of the first end core and the first core surface of the second end core coming into contact with the installation target. Therefore, compared to the reactor X, the reactor according to (2) above can easily transfer not only the heat from the coil, but also the heat from the first end core and the second end core to the installation target.

With the reactor according to (2) above, magnetic flux is unlikely to leak from the vicinity of the end faces of the coil. In the reactor according to (2) above, the first core surfaces of the first end core and the second end core are substantially flush with the first coil surface, so that the end faces of the coil are covered by the first end core and the second end core. Thus, with the reactor according to (2) above, it is easier to reduce leakage magnetic flux from the vicinity of the end faces of the coil than with a reactor Y in which the end faces of the coil are not covered by the first end core and the second end core but exposed from the first end core and the second end core.

With the reactor according to (2) above, it is easy to reduce the length of the reactor in the first direction. In the reactor according to (2) above, the length between the first and second core surfaces of the first end core and the length between the first and second core surfaces of the second end core are longer than those of the reactor Y when the volumes of the first and second end cores are fixed. Therefore, with the reactor according to (2) above, it is easier to reduce the lengths of the first end core and the second end core in the first direction than with the reactor Y when the volumes of the first and second end cores are fixed.

(3) In the reactor according to (2) above, the second core surface of the first end core and the second core surface of the second end core may be substantially flush with the second coil surface.

With the reactor according to (3) above, magnetic flux is less likely to leak from the vicinity of the end faces of the coil than with a reactor Z in which the first core surface of the first end core, the first core surface of the second end core, and the first coil surface are substantially flush with each other, and the second core surface of the first end core, the second core surface of the second end core, and a second core surface of a later-described middle core are substantially flush with each other. This is because the reactor according to (3) above has a larger region where the end faces of the coil are covered by the first end core and the second end core than that of the reactor Z. The reactor according to (3) above has more options for the surface to be brought into contact with the installation target than the reactor Z. This is because, with the reactor according to (3) above, the first coil surface, the first core surface of the first end core, and the first core surface of the second end core can be brought into contact with the installation target, or the second coil surface, the second core surface of the first end core, and the second core surface of the second end core can also be brought into contact with the installation target. When the volumes of the first end core and the second end core are fixed, the reactor according to (3) above makes it further easier to reduce the lengths in the first direction of the first end core and the second end core than the reactor Z. It is therefore easy to reduce the length of the reactor in the first direction.

(4) In the reactor according to (2) or (3) above, the side core may have an outer peripheral surface including a first core surface and a second core surface facing each other, and the first core surface of the side core may be substantially flush with the first coil surface.

The reactor according to (4) above has excellent heat dissipation properties since the first core surface of the side core can also be brought into contact with the installation target.

(5) In the reactor according to (4) above, the second core surface of the side core may be substantially flush with the second coil surface.

The reactor according to (5) above has many options for the surface to be brought into contact with the installation target. This is because, with the reactor according to (5) above, the first coil surface, the first core surface of the first end core, the first core surface of the second end core, and the first core surface of the side core can be brought into contact with the installation target, or the second coil surface, the second core surface of the first end core, the second core surface of the second end core, and the second core surface of the side core can also be brought into contact with the installation target.

(6) In the reactor according to (5) above, a first end and a second end of the winding may be drawn out in directions along the respective long sides.

When the reactor according to (6) above is installed on a planar installation target, the first coil surface, the first core surface of the first end core, the first core surface of the second end core, and the first core surface of the side core can be brought into contact with the installation target, without the first end and the second end of the winding interfering with the installation target.

(7) In the reactor according to (6) above, the first end core and the second end core may each have a second outer peripheral shape that is a rectangular shape as viewed from the first direction, and the first core surface and the second core surface of each of the first end core and the second end core may be surfaces extending along respective long sides of the second outer peripheral shape.

In the reactor according to (7) above, the first core surface of the first end core and the first core surface of the second end core are wide surfaces, so that it is easy to increase the contact area between the reactor and the installation target. In the reactor according to (7) above, the second core surface of the first end core and the second core surface of the second end core are wide surfaces, so that it is easy to increase the contact area between the reactor and the installation target.

(8) A converter according to an aspect of the present disclosure includes the reactor according to any one of (1) to (7) above.

Since the converter includes the above reactor, it has excellent performance.

(9) A power conversion apparatus according to an aspect of the present disclosure includes the converter according to (8) above.

Since the power conversion apparatus includes the above converter, it has excellent performance.

### Details of Embodiments of the Present Disclosure

Details of the embodiments of the present disclosure are described below with reference to the drawings. The same reference numerals in the figures denote items with the same names.

### Embodiment 1

### Reactor

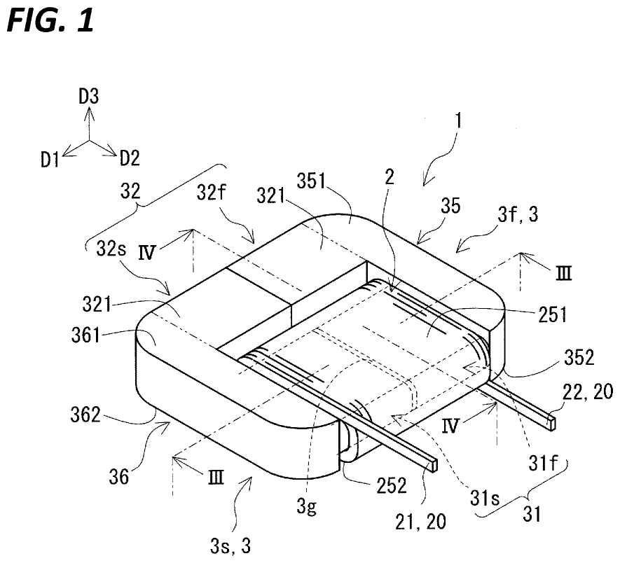

A reactor 1 of Embodiment 1 is described with reference to FIGS. 1 to 5. As shown in FIG. 1, the reactor 1 includes a coil 2 and a core 3. The coil 2 is constituted by a spirally wound winding 20. The core 3 constitutes a magnetic path passing through the inside and outside of the coil 2. One of the features of the reactor 1 of the present embodiment lies in that it satisfies the following requirements (a) to (c):
(a) one coil 2 is provided;
(b) the plan-view shape of the core 3 is an O-shape; and
(c) the coil 2 and a middle core 31 disposed inside the coil 2 have specific shapes.

In the following description, a first direction D1, a second direction D2, and a third direction D3 defined as follows are used.

The “first direction D1” is a direction along an axis of the coil 2.

The “second direction D2” is a direction along a later-described first long side L11 as shown in FIG. 5.

The “third direction D3” is a direction orthogonal to both the first direction D1 and the second direction D2.

The “width” is the length in the second direction D2.

The “thickness” is the length in the third direction D3.

The “plan-view shape” of the core 3 is its shape as viewed from the third direction D3.

### Coil

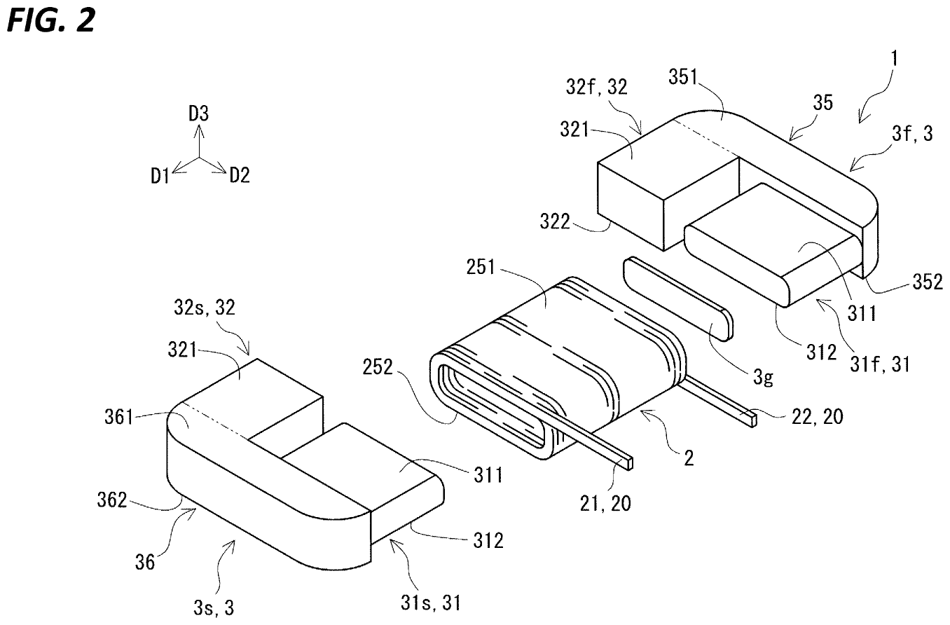

As shown in FIGS. 1 and 2, one coil 2 is provided. With the reactor 1 having one coil 2, the coil 2 can be more easily shaped than in the case of a reactor having more than one coil 2. The reactor 1 having one coil 2 has a smaller number of components than a reactor having more than one coil 2. Thus, the reactor 1 having one coil 2 is superior in producibility. Due to having one coil 2, the width of the reactor 1 can be made shorter than in the case of a reactor having a plurality of coils 2 arranged in parallel in the second direction D2. The coil 2 has a rectangular tubular shape. Since the coil 2 has a rectangular tubular shape, the contact area between the coil 2 and a planar installation target can be increased more easily than in the case of a coil 2 having a circular tubular shape with the same cross-sectional area. Thus, the reactor 1 can easily transfer the heat from the coil 2 to the installation target. The installation target is, for example, a cooling base. The four corners of the coil 2 are rounded. As shown in FIG. 5, the coil 2 has a first outer peripheral shape C1 that is a rectangular shape as viewed from the first direction D1. That is, the end face shape of the coil 2 as viewed from the first direction D1 is a rectangular frame shape. FIG. 5 shows the reactor 1 cut off at the same position as in FIG. 4. The first outer peripheral shape C1 shown in FIG. 5 is indicated by a two-dot chain line surrounding a larger area than an outer peripheral contour line of the coil 2 in order to distinguish it from the outer peripheral contour line of the coil 2 for convenience of illustration.

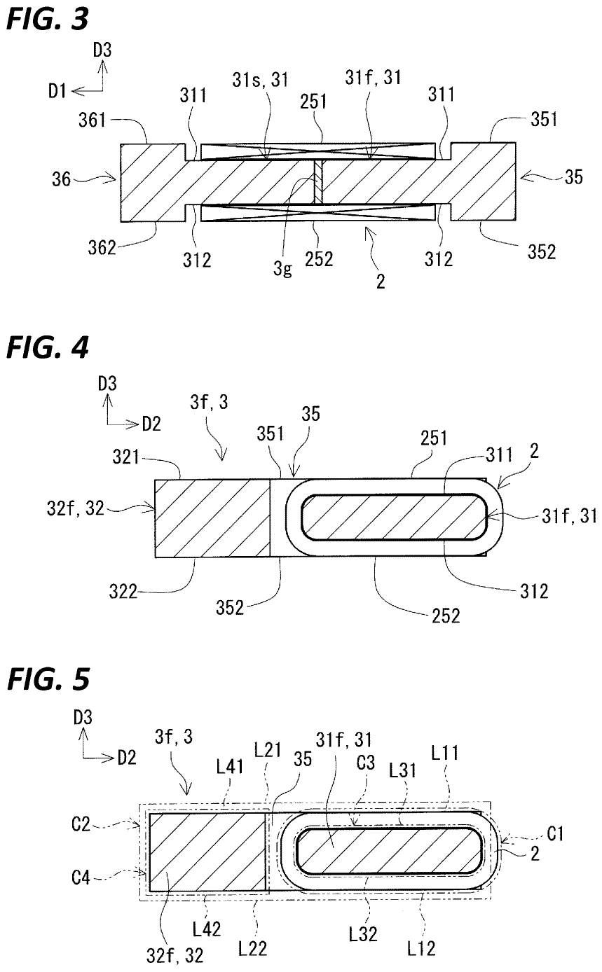

The outer peripheral surface of the coil 2 includes a first coil surface 251 and a second coil surface 252 facing each other, as shown in FIG. 3. The first coil surface 251 extends along a first long side L11 of the rectangular first outer peripheral shape C1 shown in FIG. 5. The second coil surface 252 extends along a second long side L12 of the rectangular first outer peripheral shape C1 shown in FIG. 5. The first coil surface 251 and the second coil surface 252 are flat surfaces.

The winding 20 constituting the coil 2 is a continuous winding without joints, as shown in FIGS. 1 and 2. The winding 20 is a known winding. The winding 20 of the present embodiment is a coated rectangular wire. The coated rectangular wire has a conductor wire constituted by a rectangular copper wire. The coated rectangular wire has an insulation coating made of enamel. The coil 2 of the present embodiment is formed by winding the coated rectangular wire in an edgewise manner. Unlike the present embodiment, the coil 2 may be formed by winding the coated rectangular wire in a flatwise manner.

In the present embodiment, at a first end in the first direction D1 of the coil 2, a first end 21 of the winding 20 is drawn out in a direction along the first long side L11 of the rectangular first outer peripheral shape C1 shown in FIG. 5, i.e., in a direction along the first coil surface 251 shown in FIGS. 1 and 2. At a second end in the first direction D1 of the coil 2, a second end 22 of the winding 20 is drawn out in a direction along the second long side L12 of the rectangular first outer peripheral shape C1 shown in FIG. 5, i.e., in a direction along the second coil surface 252 shown in FIGS. 1 and 2. The first end 21 and the second end 22 are drawn out in the same direction. The first end 21 and the second end 22 are drawn away from a later-described side core 32.

Although not shown in the figures, the insulation coating is removed and the conductor wire is exposed at the first end 21 and the second end 22. A terminal member is connected to the exposed conductor wire. The terminal member is not shown in the figures. An external device is connected to the coil 2 by this terminal member. The external device is not shown in the figure. The external device is, for example, a power source that supplies power to the coil 2.

### Core

As shown in FIG. 1, the plan-view shape of the core 3 is an O-shape. The core 3 includes a first end core 35, a second end core 36, a middle core 31, and a side core 32, as shown in FIGS. 1 and 2.

### First End Core and Second End Core

The first end core 35 connects a first end of the middle core 31 and a first end of the side core 32. The second end core 36 connects a second end of the middle core 31 and a second end of the side core 32. The first end core 35 and the second end core 36 have the same shape. The first end core 35 and the second end core 36 have a rectangular column shape.

In the present embodiment, the first end core 35 has a second outer peripheral shape C2 that is a rectangular shape as viewed from the first direction D1, as shown in FIG. 5. The second outer peripheral shape C2 shown in FIG. 5 is indicated by a two-dot chain line surrounding a larger area than an outer peripheral contour line of the first end core 35 in order to distinguish it from the outer peripheral contour line of the first end core 35 for convenience of illustration. Although not shown in the figures, the second end core 36 also has the second outer peripheral shape that is a rectangular shape as viewed from the first direction D1. The four corners of the second outer peripheral shape C2 are angular, but may alternatively be rounded. As shown in FIGS. 4 and 5, the first end core 35 has a width larger than its thickness. The second end core 36 has a width larger than its thickness. The first end core 35 has the same width as the second end core 36. The first end core 35 has the same thickness as the second end core 36.

The first end core 35 has an outer peripheral surface including a first core surface 351 and a second core surface 352 facing each other, as shown in FIGS. 3 and 4. The first core surface 351 extends along the first long side L21 of the rectangular second outer peripheral shape C2 shown in FIG. 5. The second core surface 352 extends along the second long side L22 of the rectangular second outer peripheral shape C2 shown in FIG. 5. In the present embodiment, the plan-view shape of the first core surface 351 and the second core surface 352 is a trapezoidal shape in which the width of the first end core 35 narrows from its first end face proximal to the middle core 31 and the side core 32 toward its second end face distal therefrom, as shown in FIGS. 1 and 2.

The second end core 36 has an outer peripheral surface including a first core surface 361 and a second core surface 362 facing each other, as shown in FIGS. 2 and 3. The first core surface 361 extends along the first long side of the rectangular second outer peripheral shape. The second core surface 362 extends along the second long side of the rectangular second outer peripheral shape. In the present embodiment, the plan-view shape of the first core surface 361 and the second core surface 362 is a trapezoidal shape in which the width of the second end core 36 narrows from its first end face proximal to the middle core 31 and the side core 32 toward its second end face distal therefrom, as shown in FIGS. 1 and 2.

In the present embodiment, the first core surface 351 and the first core surface 361 are substantially flush with the first coil surface 251, as shown in FIG. 3. Since these surfaces are substantially flush, the maximum difference in the third direction D3 between the first core surface 351, the first core surface 361, and the first coil surface 251 can be reduced, and this maximum difference can be made close to 0 (zero). In the reactor 1, the first end 21 and the second end 22 are drawn out in the direction along the first long side L11 and the second long side L12 of the rectangular first outer peripheral shape C1 shown in FIG. 5, and the first coil surface 251, the first core surface 351, and the first core surface 361 are flush with each other, as described above. Thus, when the reactor 1 is installed on a planar installation target, the first coil surface 251, the first core surface 351, and the first core surface 361 can be brought into contact with the installation target without the first end 21 and the second end 22 interfering with the installation target. Therefore, with the reactor 1, the contact area between the reactor 1 and the installation target can be increased compared to a reactor X in which only the first coil surface 251 comes into contact with the installation target without the first core surface 351 and the first core surface 361 coming into contact with the installation target.

In particular, the first core surface 351 and the second core surface 352 are wide surfaces as they extend along the first long side L21 and the second long side L22 of the rectangular second outer peripheral shape C2 shown in FIG. 5. This can increase the contact area with the installation target. Compared to the aforementioned reactor X, the reactor 1 can easily transfer not only the heat from the coil 2, but also the heat from the first end core 35 and the second end core 36 to the installation target. Thus, with the reactor 1, the heat dissipation properties can be more easily improved than with the reactor X. That is, the first core surface 351, the first core surface 361, and the first coil surface 251 shown in FIG. 3 are substantially flush with each other. For this reason, it can be said that the first end core 35, the second end core 36, and the coil 2 have a thickness dimension that makes it easy to ensure heat dissipation properties. The flatness of the first core surface 351, the first core surface 361, and the first coil surface 251, which are substantially flush, may be, for example, 0.4 mm or less, and may further be 0.2 mm or less, 0.1 mm or less, and 0.05 mm or less. The flatness referred to here complies with JIS B 0621:1984 definition and indication of geometric deviation.

In the reactor 1, the first core surface 351 and the first core surface 361 are substantially flush with the first coil surface 251, so that the end faces of the coil 2 are covered by the first end core 35 and the second end core 36. That is, the end faces of the coil 2 face the first end core 35 and the second end core 36. Thus, the reactor 1 can reduce leakage magnetic flux from the vicinity of the end faces of the coil 2 more easily than a reactor Y in which the end faces of the coil 2 are not covered by the first end core 35 and the second end core 36 but exposed from the first end core 35 and the second end core 36. Accordingly, with the reactor 1, magnetic flux is less likely to leak from the vicinity of the end faces of the coil 2 than with the reactor Y. Unlike the present embodiment, the first core surface 351 and the first core surface 361 need not necessarily be flush with the first coil surface 251.

In the present embodiment, the second core surface 352 and the second core surface 362 are substantially flush with the second coil surface 252. Since these surfaces are substantially flush, the maximum difference in the third direction D3 between the second core surface 352, the second core surface 362, and the second coil surface 252 can be reduced, and this maximum difference can be made close to 0 (zero). With the reactor 1, magnetic flux is less likely to leak from the vicinity of the end faces of the coil 2 than with a reactor Z in which the first core surface 351, the first core surface 361, and the first coil surface 251 are substantially flush with each other, and the second core surface 352, the second core surface 362, and a second core surface 312 are substantially flush with each other. This is because the reactor 1 has a larger region where the end faces of the coil 2 are covered by the first end core 35 and the second end core 36 than that of the above reactor Z. That is, the region is larger where the end faces of the coil 2 face the first end core 35 and the second end core 36. The reactor 1 has more options for the surface to be brought into contact with the installation target than the reactor Z. This is because, with the reactor 1, the first coil surface 251, the first core surface 351, and the first core surface 361 can be brought into contact with the installation target, or the second coil surface 252, the second core surface 352, and the second core surface 362 can also be brought into contact with the installation target. The second core surface 352, the second core surface 362, and the second coil surface 252 shown in FIG. 3 are substantially flush with each other. For this reason, it can be said that the first end core 35, the second end core 36, and the coil 2 have a thickness dimension that makes it easy to ensure heat dissipation properties. The flatness of the second core surface 352, the second core surface 362, and the second coil surface 252, which are substantially flush, may be, for example, 0.4 mm or less, and may further be 0.2 mm or less, 0.1 mm or less, and 0.05 mm or less. Unlike the present embodiment, the second core surface 352 and the second core surface 362 need not necessarily be flush with the second coil surface 252.

### Middle Core

As shown in FIGS. 1, 3, and 4, the middle core 31 has a portion disposed inside the coil 2. The shape of the middle core 31 corresponds to the shape of an inner peripheral contour of the coil 2. The middle core 31 has a rectangular column shape. As shown in FIG. 5, the middle core 31 has a third outer peripheral shape C3 that is a rectangular shape as viewed from the first direction D1. The third outer peripheral shape C3 shown in FIG. 5 is indicated by a two-dot chain line surrounding a larger area than an outer peripheral contour line of the middle core 31 in order to distinguish it from the outer peripheral contour line of the middle core 31 for convenience of illustration. The four corners of the third outer peripheral shape C3 are rounded along the four corners of the inner peripheral surface of the coil 2. The middle core 31 and the side core 32 are arranged in parallel along a first long side L31 of the third outer peripheral shape C3.

The middle core 31 has a width larger than its thickness. The width of the middle core 31 is larger than the width of the side core 32. In the reactor 1, the coil 2 is disposed on the middle core 31 having a larger width than the side core 32, and thus has a larger width than that of a reactor W in which the coil 2 is disposed on the middle core 31 having the same width as the side core 32. When the reactor 1 is installed on a planar installation target, a surface of the coil 2 that has a large width comes into contact with the installation target. Thus, with the reactor 1, the contact area between the coil 2 and the installation target can be made larger than the above reactor W. The reactor 1 can transfer the heat from the coil 2 to the installation target more easily than the reactor W. Accordingly, the reactor 1 has excellent heat dissipation properties. In the reactor 1, the coil 2 is disposed on the middle core 31 having a larger width than the side core 32, and the cross-sectional area of the coil 2 can thereby be made larger than that of the reactor W. Thus, even though the reactor 1 has only one coil 2, the inductance thereof can be easily made larger than that of the reactor W. Accordingly, the reactor 1 has excellent inductance. The thickness of the middle core 31 is smaller than the thickness of the first end core 35.

The middle core 31 has an outer peripheral surface including a first core surface 311 and a second core surface 312 facing each other. The first core surface 311 extends along the first long side L31 of the rectangular third outer peripheral shape C3 shown in FIG. 5. The second core surface 312 extends along the second long side L32 of the rectangular third outer peripheral shape C3 shown in FIG. 5. The middle core 31 of the present embodiment is constituted by two core portions, namely a first middle core portion 31f and a second middle core portion 31s, as shown in FIGS. 1 to 3. Unlike the present embodiment, the middle core 31 may alternatively be constituted by a single member.

### Side Core

As shown in FIGS. 1 and 2, the side core 32 is disposed in parallel with the middle core 31, and the coil 2 is not disposed on the side core 32. The side core 32 has a rectangular column shape. As shown in FIG. 5, the side core 32 has a fourth outer peripheral shape C4 that is a rectangular shape as viewed from the first direction D1. The fourth outer peripheral shape C4 shown in FIG. 5 is indicated by a two-dot chain line surrounding a larger area than an outer peripheral contour line of the side core 32 in order to distinguish it from the outer peripheral contour line of the side core 32 for convenience of illustration. The four corners of the fourth outer peripheral shape C4 are angular, but may alternatively be rounded.

The side core 32 has a width larger than its thickness. The thickness of the side core 32 of the present embodiment is larger than the thickness of the middle core 31. Unlike the present embodiment, the thickness of the side core 32 may alternatively be equal to the thickness of the middle core 31. The thickness of the side core 32 of the present embodiment is the same as the thickness of the first end core 35 and the thickness of the second end core 36. Unlike the present embodiment, the thickness of the side core 32 may alternatively be smaller than the thickness of the first end core 35 and the thickness of the second end core 36.

The side core 32 has an outer peripheral surface including a first core surface 321 and a second core surface 322 facing each other, as shown in FIGS. 2 and 4. The first core surface 321 extends along a first long side L41 of the rectangular fourth outer peripheral shape C4 as shown in FIG. 5. The second core surface 322 extends along a second long side L42 of the rectangular fourth outer peripheral shape C4.

The first core surface 321 of the present embodiment is substantially flush with the first coil surface 251. That is, the first core surface 321 of the present embodiment is substantially flush with the first core surface 351 and the first core surface 361, as shown in FIG. 1. Since these surfaces are substantially flush, the maximum difference in the third direction D3 between the first core surface 321 and the first coil surface 251 can be reduced, and this maximum difference can be made close to 0 (zero). The reactor 1 has excellent heat dissipation properties since the first core surface 321 can also be brought into contact with the installation target. The flatness of the first core surface 321, which is substantially flush with the first coil surface 251, may be, for example, 0.4 mm or less, and may further be 0.2 mm or less, 0.1 mm or less, and 0.05 mm or less. Unlike the present embodiment, the first core surface 321 need not necessarily be flush with the first coil surface 251.

The second core surface 322 of the present embodiment is substantially flush with the second coil surface 252, as shown in FIG. 4. That is, the second core surface 322 of the present embodiment is also substantially flush with the second core surface 352 and the second core surface 362. Since these surfaces are substantially flush, the maximum difference in the third direction D3 between the second core surface 322 and the second coil surface 252 can be reduced, and this maximum difference can be made close to 0 (zero). The reactor 1 has many options for the surface to be brought into contact with the installation target. This is because, with the reactor 1, the first coil surface 251, the first core surface 351, the first core surface 361, and the first core surface 321 can be brought into contact with the installation target, or the second coil surface 252, the second core surface 352, the second core surface 362, and the second core surface 322 can also be brought into contact with the installation target. The flatness of the second core surface 322, which is substantially flush with the second coil surface 252, may be, for example, 0.4 mm or less, and may further be 0.2 mm or less, 0.1 mm or less, and 0.05 mm or less. Unlike the present embodiment, the second core surface 322 need not necessarily be flush with the second coil surface 252.

As shown in FIG. 1, the length of the side core 32 in the first direction D1 is longer than the length of the middle core 31 in the first direction D1. The length of the middle core 31 in the first direction D1 does not include the length in the first direction D1 of a later-described gap portion 3g. The same applies to the lengths of the other cores. The length of the middle core 31 in the first direction D1 is the total length of the length of the later-described first middle core portion 31f in the first direction D1 and the length of the second middle core portion 31s in the first direction D1. The side core 32 of the present embodiment includes two core portions, namely a first side core portion 32f and a second side core portion 32s. The length of the side core 32 in the first direction D1 is the total length of the length of the later-described first side core portion 32f in the first direction D1 and the length of the second side core portion 32s in the first direction D1.

The core 3 of the present embodiment is an assembly combining a first core 3f and a second core 3s, as shown in FIGS. 1 and 2. The first core 3f and the second core 3s can be combined in various manners by selecting the shape of the first core 3f and the shape of the second core 3s as appropriate. The shape of the first core 3f and the shape of the second core 3s may be symmetrical or asymmetrical with respect to each other. “Symmetrical” means that the shapes and sizes are the same. “Asymmetrical” means that the shapes are different. In the present embodiment, the shape of the first core 3f and the shape of the second core 3s are symmetrical. In the present embodiment, the core 3 is divided into the first core 3f and the second core 3s along the first direction D1. In the present embodiment, the combination of the first core 3f and the second core 3s is of a U-U type. Unlike the present embodiment, the above combination may alternatively be of a U-I type, J-L type, J-J type, or L-L type (not shown). The reactor 1 can be constructed by combining the first core 3f and the second core 3s with the coil 2 along the axis of the coil 2. Thus, the reactor 1 has excellent manufacturing workability. The later-described gap portion 3g may be provided between the first core 3f and the second core 3s, but need not necessarily be provided. Unlike the present embodiment, the core 3 may be a one-piece body.

### First Core

The first core 3f includes the first end core 35 and at least one selected from the group consisting of at least a portion of the middle core 31 and at least a portion of the side core 32. For example, when the first core 3f includes the first end core 35, and either at least a portion of the middle core 31 or at least a portion of the side core 32, the plan-view shape of the first core 3f is an L-shape. When the first core 3f includes at least a portion of the middle core 31, at least a portion of the side core 32, and the first end core 35, the plan-view shape of the first core 3f is a U-shape or J-shape. When the portion of the middle core 31 and the portion of the side core 32 have the same length in the first direction D1, the plan-view shape of the first core 3f is a U-shape. When the portion of the middle core 31 and the portion of the side core 32 have different lengths in the first direction D1, the plan-view shape of the first core 3f is a J-shape.

The plan-view shape of the first core 3f of the present embodiment is a U-shape. The first core 3f of the present embodiment includes the first middle core portion 31f, the first side core portion 32f, and the first end core 35. The first core 3f is a molded body in which the first middle core portion 31f, the first side core portion 32f, and the first end core 35 are integrated. In FIGS. 1 and 2, the boundary between the first side core portion 32f and the first end core 35 is indicated by a two-dot chain line for convenience of illustration. The first end core 35 connects the first middle core portion 31f and the first side core portion 32f. The first middle core portion 31f and the first side core portion 32f are located at respective ends of the first end core 35 in a direction along the width thereof.

### Second Core

Depending on the combination of the first core 3f and the second core 3s, the second core 3s may be constituted only by the second end core 36 or may have the second end core 36 and at least one selected from the group consisting of the remainder of the middle core 31 and the remainder of the side core 32. For example, when the second core 3s is constituted by one second end core 36, the plan-view shape of the second core 3s is an I-shape. When the second core 3s includes the second end core 36 and either the remainder of the middle core 31 or the remainder of the side core 32, the plan-view shape of the second core 3s is an L-shape. When the second core 3s includes the remainder of the middle core 31, the remainder of the side core 32, and the second end core 36, the plan-view shape of the second core 3s is a U-shape or J-shape. When the remainder of the middle core 31 and the remainder of the side core 32 have the same length in the first direction D1, the plan-view shape of the second core 3s is a U-shape. When the remainder of the middle core 31 and the remainder of the side core 32 have different lengths in the first direction D1, the plan-view shape of the second core 3s is a J-shape.

The plan-view shape of the second core 3s of the present embodiment is a U-shape. The second core 3s of the present embodiment includes the second middle core portion 31s, the second side core portion 32s, and the second end core 36. The second core 3s is a molded body in which the second middle core portion 31s, the second side core portion 32s, and the second end core 36 are integrated. In FIGS. 1 and 2, the boundary between the second side core portion 32s and the second end core 36 is indicated by a two-dot chain line for convenience of illustration. The second end core 36 connects the second middle core portion 31s and the second side core portion 32s. The second middle core portion 31s and the second side core portion 32s are located at respective ends of the second end core 36 in a direction along the width thereof.

In the present embodiment, the length of the first middle core portion 31f in the first direction D1 is shorter than the length of the first side core portion 32f in the first direction D1.

Unlike the present embodiment, the length of the first middle core portion 31f in the first direction D1 may be longer than the length of the second middle core portion 31s in the first direction D1. The length of the first side core portion 32f in the first direction D1 may be longer than the length of the second side core portion 32s in the first direction D1. The length of the first middle core portion 31f in the first direction D1 may be equal to the length of the first side core portion 32f in the first direction D1.

In the present embodiment, the first core 3f and the second core 3s are combined such that an end face of the first side core portion 32f and an end face of the second side core portion 32s are in contact with each other. With the combination in this manner, a space is provided between an end face of the first middle core portion 31f and an end face of the second middle core portion 31s, since the aforementioned length relationship is satisfied. A gap portion 3g is formed between the end face of the first middle core portion 31f and the end face of the second middle core portion 31s. The gap portion 3g is constituted by a member made of a material having a relative permeability smaller than that of the first core 3f and the second core 3s. The gap portion 3g is made of the same resin as a resin of a later-described molded body of a composite material. The gap portion 3g may also be made of a mixed material containing a later-described filler in the resin.

Each of the first core 3f and the second core 3s is made of a molded body of a composite material, or a powder compact. In the present embodiment, the first core 3f is made of a molded body of a composite material, and the second core 3s is made of a powder compact. Unlike the present embodiment, both the first core 3f and the second core 3s may be made of a molded body of a composite material, or may be made of a powder compact.

The molded body of the composite material is a molded body in which soft magnetic powder is dispersed in a resin. The molded body of the composite material is obtained by filling a mold with a fluid material in which the soft magnetic powder is dispersed in unsolidified resin, and then solidifying the resin. In the molded body of the composite material, the content of the soft magnetic powder in the resin can be adjusted easily. Thus, the magnetic properties of the molded body of the composite material can be easily adjusted. In addition, the molded body of the composite material can be easily formed into a complex shape compared to the powder compact. The content of the soft magnetic powder in the molded body of the composite material is, for example, 20 volume % or more and 80 volume % or less. The content of the resin in the molded body of the composite material is, for example, 20 volume % or more and 80 volume % or less. These contents are the proportions when the volume of the molded body of the composite material is 100%.

The powder compact is a compacted body formed by compacting soft magnetic powder. The powder compact can make the proportion of the soft magnetic powder occupying the core portion higher than the molded body of the composite material. Thus, the powder compact can easily enhance the magnetic properties. The magnetic properties include relative permeability and saturation magnetic flux density. Further, the powder compact contains less resin and more soft magnetic powder than the molded body of the composite material, and thus has excellent heat dissipation properties. The content of the soft magnetic powder in the powder compact is, for example, 85 volume % or more and 99 volume % or less. This content is the proportion when the volume of the powder compact is 100%.

Particles constituting the soft magnetic powder are, for example, soft magnetic metal particles, coated particles, or soft magnetic non-metal particles. The coated particles include particles of soft magnetic metal and an insulating coating provided on the outer periphery of the particles of the soft magnetic metal. The soft magnetic metal is, for example, pure iron or an iron-based alloy. The iron-based alloy is, for example, a Fe-Si alloy or a Fe-Ni alloy. The insulating coating is, for example, phosphate. The soft magnetic non-metal is, for example, ferrite.

The resin of the molded body of the composite material is, for example, a thermosetting resin or a thermoplastic resin. The thermosetting resin is, for example, epoxy resin, phenol resin, silicone resin, or urethane resin. The thermoplastic resin is, for example, polyphenylene sulfide resin, polyamide resin, liquid crystal polymer, polyimide resin, or fluorine resin. The polyamide resin is, for example, nylon 6, nylon 66, or nylon 9T.

The molded body of the composite material may contain a filler. The filler is, for example, alumina or silica. The filler contributes to the improvement of heat dissipation properties and electrical insulation properties.

The content of the soft magnetic powder in the molded body of the composite material and the content of the soft magnetic powder in the powder compact are regarded as equivalent to the areal proportion of the soft magnetic powder in a cross section of the molded body (compact). The content of the soft magnetic powder in the molded body (compact) is obtained as follows. A cross section of the molded body (compact) is observed with a SEM (Scanning Electron Microscope), and an observation image is acquired. The cross section of the molded body (compact) is any cross section. The magnification of the SEM is 200 times or more and 500 times or less. The number of observation images acquired is 10 or more. The total cross-sectional area is 0.1 cm² or more. One observation image may be acquired for one cross section, or a plurality of observation images may be acquired for one cross section. Each of the acquired observation images is image-processed to extract the contours of the particles. The image processing may be, for example, binary processing. The areal proportion of the soft magnetic particles in each observation image is calculated, and an average value of the areal proportions is obtained. This average value is regarded as the content of the soft magnetic powder.

### Embodiment 2

### Converter and Power Conversion Apparatus

The reactor 1 of Embodiment 1 can be used for applications that satisfy the following current-carrying conditions. Examples of the current-carrying conditions include a maximum direct current (DC) of about 100 A or more and 1000 A or less, an average voltage of about 100 V or more and 1000 V or less, and an operating frequency of about 5 kHz or more and 100 kHz or less. The reactor 1 of Embodiment 1 can be used as a component of a converter mounted in a vehicle 1200, which is typically an electric vehicle, a hybrid vehicle, or a fuel cell vehicle, or as a component of a power conversion apparatus that includes this converter.

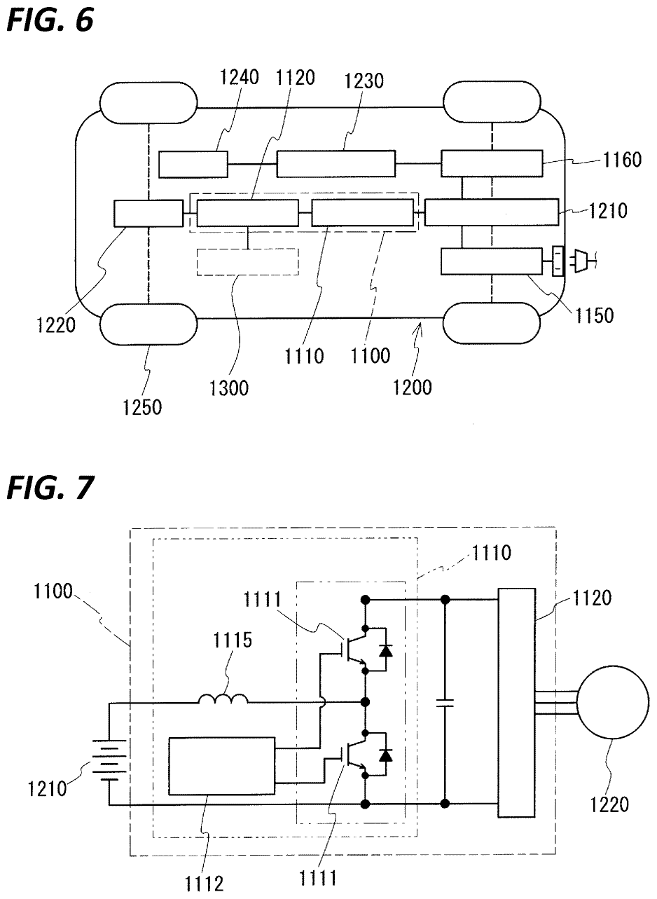

As shown in FIG. 6, the vehicle 1200 includes a main battery 1210, a power conversion apparatus 1100 connected to the main battery 1210, and a motor 1220 driven by power supplied from the main battery 1210 to be used for traveling. The motor 1220 is typically a three-phase alternating current (AC) motor. The motor 1220 drives wheels 1250 during travel and functions as a generator during regeneration. When the vehicle 1200 is a hybrid vehicle, it includes an engine 1300 in addition to the motor 1220. FIG. 6 shows an example in which a charging portion of the vehicle 1200 is an inlet. Although not shown, the charging portion of the vehicle 1200 may be provided with a plug.

The power conversion apparatus 1100 includes a converter 1110 connected to the main battery 1210 and an inverter 1120 connected to the converter 1110. The inverter 1120 performs mutual conversion between AC and DC. When the vehicle 1200 travels, the converter 1110 illustrated in this example steps up an input voltage of the main battery 1210 of about 200 V or more and 300 V or less, to about 400 V or more and 700 V or less, and supplies power to the inverter 1120. During regeneration, the converter 1110 steps down an input voltage output from the motor 1220 to a DC voltage suitable for the main battery 1210 to charge the main battery 1210. The input voltage is a DC voltage. When the vehicle 1200 travels, the inverter 1120 converts the DC voltage stepped up by the converter 1110 to a predetermined AC voltage, and supplies power to the motor 1220. During regeneration, the inverter 1120 converts the AC output from the motor 1220 to DC and outputs it to the converter 1110.

As shown in FIG. 7, the converter 1110 includes a plurality of switching elements 1111, a drive circuit 1112 for controlling the operation of the switching elements 1111, and a reactor 1115, and converts the input voltage by repeatedly turning on and off. The “conversion of the input voltage” here is the step-up and step-down of the input voltage. The switching elements 1111 are power devices such as field effect transistors or insulated gate bipolar transistors. The reactor 1115 has a function of smoothing out the change in current when the current is about to increase or decrease due to the switching operation, by using the nature of the coil, which attempts to prevent changes in the current flowing through the circuit. The reactor 1 of Embodiment 1 is provided as the reactor 1115. By including this reactor 1, the power conversion apparatus 1100 and the converter 1110 have excellent performance.

The vehicle 1200 includes, in addition to the converter 1110, a power supply device converter 1150 connected to the main battery 1210, and an auxiliary power supply converter 1160 for converting a high voltage of the main battery 1210 to a low voltage. The auxiliary power supply converter 1160 is connected to a sub-battery 1230 and the main battery 1210, which are power sources for auxiliary devices 1240. The converter 1110 typically performs DC-DC conversion. The power supply device converter 1150 and the auxiliary power supply converter 1160 perform AC-DC conversion. Some types of power supply device converters 1150 perform DC-DC conversion. Reactors of the power supply device converter 1150 and the auxiliary power supply converter 1160 may be those having the same configuration as the reactor 1 of Embodiment 1 or the like and having a size, shape, or the like modified as appropriate. Further, the reactor 1 of Embodiment 1, or the like can also be used as a converter that converts input power and that only steps up or steps down voltage.

The present invention is not limited to these examples but is defined by the claims, and is intended to include all changes made within the meaning and scope equivalent to the claims.

### LIST OF REFERENCE NUMERALS

1 Reactor
2 Coil, 20 Winding, 21 First end, 22 Second end
251 First coil surface, 252 Second coil surface
3 Core, 3f First core, 3s Second core, 3g Gap portion
31 Middle core, 311 First core surface, 312 Second core surface
31f First middle core portion, 31s Second middle core portion
32 Side core, 321 First core surface, 322 Second core surface
32f First side core portion, 32s Second side core portion
35 First end core, 351 First core surface, 352 Second core surface
36 Second end core, 361 First core surface, 362 Second core surface
D1 First direction, D2 Second direction, D3 Third direction
C1 First outer peripheral shape, L11 First long side, L12 Second long side
C2 Second outer peripheral shape, L21 First long side, L22 Second long side
C3 Third outer peripheral shape, L31 First long side, L32 Second long side
C4 Fourth outer peripheral shape, L41 First long side, L42 Second long side
1100 Power conversion apparatus, 1110 Converter
1111 Switching element, 1112 Drive circuit
1115 Reactor, 1120 Inverter
1150 Power supply device converter, 1160 Auxiliary power supply converter
1200 Vehicle, 1210 Main battery, 1220 Motor
1230 Sub-battery, 1240 Auxiliary device
1250 Wheel, 1300 Engine

1. A reactor comprising:
a coil including a spirally wound winding; and
a core formed to pass through an inside and outside of the coil,
wherein there is one coil,
the core includes:
a middle core disposed inside the coil;
a side core arranged in parallel with the middle core, without the coil being disposed on the side core;
a first end core connected to a first end of the middle core and a first end of the side core; and
a second end core connected to a second end of the middle core and a second end of the side core,
there is one side core,
the middle core has a width larger than a width of the side core,
the coil has a first outer peripheral shape that is a rectangular shape as viewed from a first direction along an axis of the coil,
the coil has an outer peripheral surface including a first coil surface and a second coil surface facing each other and extending along respective long sides of the first outer circumferential shape,
the first end core and the second end core each have an outer peripheral surface including a first core surface and a second core surface facing each other,
the side core has an outer peripheral surface including a first core surface and a second core surface facing each other,
the first core surface of the first end core, the first core surface of the second end core, and the first core surface of the side core are substantially flush with the first coil surface, and
the second core surface of the first end core, the second core surface of the second end core, and the second core surface of the side core are substantially flush with the second coil surface.

2. The reactor according to claim 1,
wherein the middle core has a width larger than a thickness thereof.

3. The reactor according to claim 2,
wherein the side core has a width larger than a thickness thereof.

4. The reactor according to claim 1,
wherein a first end and a second end of the winding are drawn out in directions along the respective long sides and away from the side core.

5. The reactor according to claim 1,
wherein the first end core and the second end core each have a second outer peripheral shape that is a rectangular shape as viewed from the first direction, and
the first core surface and the second core surface of each of the first end core and the second end core are surfaces extending along respective long sides of the second outer peripheral shape.

6. A converter comprising the reactor according to claim 1.

7. A power conversion apparatus comprising the converter according to claim 6.

8. (canceled)

9. (canceled)
